(19) United States
(12) Patent Application Publication
(10) Pub. No.: US 2009/0231782 A1
(43) Pub. Date: Sep. 17, 2009

(54) SOLID ELECTROLYTIC CAPACITOR

(75) Inventors: Masayuki FUJITA, Kyoto (JP); Takashi UMEMOTO, Hirakata (JP); Hiroshi NONOUE, Hirakata (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD., Moriguchi (JP)

(21) Appl. No.: 12/401,115

(22) Filed: Mar. 10, 2009

(30) Foreign Application Priority Data
Mar. 13, 2008 (JP) JP2008-063412

(51) Int. Cl. H01G 9/025; C25D 7/00

(52) U.S. Cl. 361/525; 205/50

(57) ABSTRACT

A solid electrolytic capacitor that suppresses capacitance decrease caused by thermal loads. The solid electrolytic capacitor includes an anode body, a dielectric layer formed on a surface of the anode body, a conductive polymer layer formed on the dielectric layer, and a cathode layer formed on the conductive polymer layer. The conductive polymer layer contains a filler material having a negative linear expansion coefficient.

### CROSS-REFERENCE TO RELATED APPLICATIONS

This application is based upon and claims the benefit of priority from the prior Japanese Patent Application No. 2008-063412, filed on Mar. 13, 2008, the entire contents of which are incorporated herein by reference.

### BACKGROUND OF THE INVENTION

The present invention relates to a solid electrolytic capacitor.

A typical solid electrolytic capacitor is manufactured by press forming and sintering metal powder having a valve effect, such as niobium (Nb) and tantalum (Ta), together with an anode lead to form a sintered body. Then, the sintered body is anodized. This forms a dielectric layer mainly containing oxides on the surface of the sintered body. Subsequently, a conductive polymer layer (for example, polypyrrole or polythiophene) is formed on the dielectric layer, and a cathode layer (for example, a laminated layer of a conductive carbon layer and a silver paste layer) is formed on the dielectric layer. This forms a capacitor element. Afterwards, the anode lead and an anode terminal are welded and connected together, and a cathode layer and cathode terminal are connected together by a conductive adhesive. Further, a transfer process is performed to mold a mold package around the capacitor element. This completes a solid electrolytic capacitor. Japanese Laid-Open Patent Publication No. 2006-186083 describes such a solid electrolytic capacitor.

However, in the solid electrolytic capacitor described in the above publication, stripping occurs at the interface between the dielectric layer and the conductive polymer layer. This may decreases the capacitance. In particular, when inspections are conducted under high temperatures or when thermal treatment is performed during a reflow soldering process, the layer separation at the interface becomes more eminent and the capacitance further decreases. Thus, there is a strong demand for improvement in such characteristics of recent solid electrolytic capacitors.

### SUMMARY OF THE INVENTION

The present invention provides a solid electrolytic capacitor that suppresses capacitance decrease caused by thermal loads.

One aspect of the present invention is a solid electrolytic capacitor including an anode body, a dielectric layer formed on a surface of the anode body, a conductive polymer layer formed on the dielectric layer, and a cathode layer formed on the conductive polymer layer. The conductive polymer layer contains a filler material having a negative linear expansion coefficient.

Another aspect of the present invention is a method for manufacturing a solid electrolytic capacitor including forming an anode body from a valve metal, forming a dielectric layer on a surface of the anode body by anodizing the anode body, forming a conductive polymer layer on the dielectric layer by using a polymerization liquid containing a filler material that has a negative linear expansion coefficient so that the conductive polymer layer contains the filler material, and forming a cathode layer on the conductive polymer layer.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a schematic cross-sectional view showing the structure of a solid electrolytic capacitor according to a preferred embodiment of the present invention;

FIG. 1B is a partially enlarged view showing the vicinity of a conductive polymer layer in the solid electrolytic capacitor of FIG. 1A;

FIG. 2 is a chart showing evaluation results of the capacitance retention ratio for a niobium solid electrolytic capacitor; and

FIG. 3 is a chart showing evaluation results of the capacitance retention ratio for a tantalum sold electrolytic capacitor.

### DETAILED DESCRIPTION OF THE PREFERRED EMBODIMENTS

A solid electrolytic capacitor according to a preferred embodiment of the present invention will now be discussed with reference to the drawings. The present invention is not limited to the preferred embodiment in any manner.

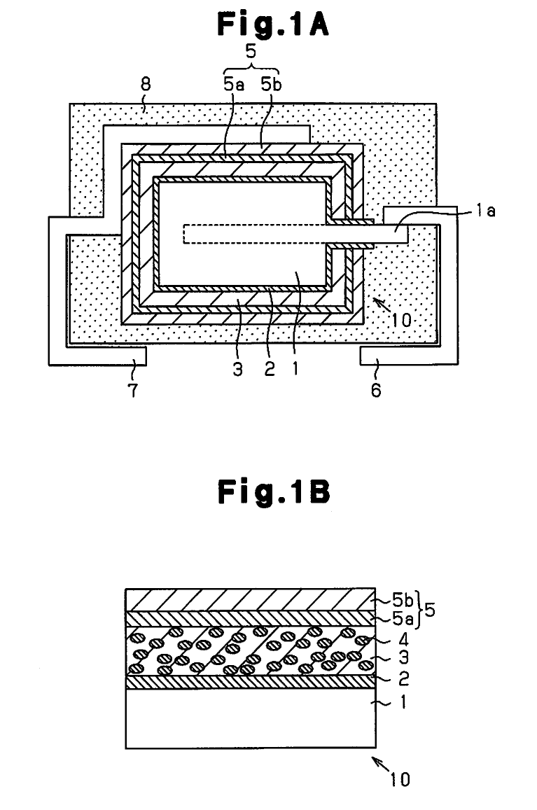

FIG. 1 includes schematic cross-sectional views showing the structure of a solid electrolytic capacitor of the preferred embodiment. FIG. 1A is a schematic cross-sectional view entirely showing the solid electrolytic capacitor, and FIG. 1B is a partially enlarged view showing the vicinity of a conductive polymer layer in the solid electrolytic capacitor.

Referring to FIG. 1A, the solid electrolytic capacitor has a capacitor element 10 including an anode body 1 out of which an anode lead 1a extends, a dielectric layer 2 formed on a surface of the anode body 1, a conductive polymer layer 3 formed on the dielectric layer 2, and a cathode layer 5 formed on the conductive polymer layer 3. As shown in FIG. 1B, the conductive polymer layer 3 entirely contains filler material 4, which has a negative linear expansion coefficient. As shown in FIG. 1A, a plate-shaped cathode terminal 7 is bonded to the cathode layer 5 of the capacitor element 10 by a conductive adhesive (not shown). A plate-shaped anode terminal 6 is bonded to the anode lead 1a. A mold package 8, which is formed from epoxy resin or the like, is molded in a state in which the anode terminal 6 and the cathode terminal 7 are partially extended out of the mold package 8.

The structure of a solid electrolytic capacitor will now be described in detail.

The anode body 1 is a porous sintered body formed from metal powder of valve metal, and the anode lead 1a is a rod-shaped lead also formed from a valve metal. The anode lead 1a is embedded in the anode body 1 in a state partially projecting out of the anode body 1. The valve metal of the anode lead 1a and the anode body 1 is a metal material enabling the formation of an insulative oxide film and is one of metals such as niobium (Nb), tantalum (Ta), aluminum (Al), and titanium (Ti). An alloy of these valve metals may also be used. The anode body 1 and the anode lead 1a may use the same type of valve metal or different types of valve metals.

The dielectric layer 2 is a dielectric formed from oxides of the valve metal and has a predetermined thickness on the surface of the anode body 1. For example, if the valve metal includes a niobium metal, the dielectric layer 2 is a niobium oxide.

The conductive polymer layer 3 functions as an electrolyte layer and is arranged on the surface of the dielectric layer 2. The material of the conductive polymer layer 3 is not particularly limited as long as it is a conductive polymer material. Materials such as polyethylenedioxythiophene, polypyrrole, polythiophene, and polyaniline, which have superior conductivity, and derivatives of these materials may be used for the conductive polymer layer 3. The filler material 4, which has a negative linear expansion coefficient, is distributed throughout the conductive polymer layer 3. The filler material 4 has a characteristic in which it contracts under a thermal load (heating to a high temperature) so as to become dispersed in the conductive polymer layer 3. This reduces the thermal expansion of the conductive polymer layer 3 caused by thermal loads.

For example, the cathode layer 5 is a laminated layer of a conductive carbon layer 5a, which contains carbon grains, and a silver paste layer 5b, which contains silver grains. The cathode layer 5 is arranged on the conductive polymer layer 3. In addition to carbon, semiconductor grains or metal powder, such as silver or aluminum, may be used as a cathode material.

The capacitor element 10 is formed by the anode body 1, the dielectric layer 2, the conductive polymer layer 3, and the cathode layer 5. The anode lead 1a extends out of the anode body 1.

The anode terminal 6 and the cathode terminal 7 are plate-shaped and preferably formed from a conductive material, such as copper (Cu) or nickel (Ni). Further, the anode terminal 6 and the cathode terminal 7 each function as an external lead terminal of the solid electrolytic capacitor. The anode terminal 6 is spot-welded and bonded to the anode lead 1a. The cathode terminal 7 is bonded to the cathode layer 5 by the conductive adhesive (not shown).

The mold package 8, which is formed from epoxy resin or the like, is molded in a state in which the anode terminal 6 and the cathode terminal 7 partially extend out of the mold package 8 in opposite directions. End portions of the anode terminal 6 and the cathode terminal 7, which are exposed from the mold package 8, are bent along the side surface and lower surface of the mold package 8 and function as terminals when the solid electrolytic capacitor is connected (soldered) to a mounting substrate.

The anode body 1 serves as the “anode body” of the present invention. The dielectric layer 2 serves as the “dielectric layer” of the present invention. The conductive polymer layer 3 serves as the “conductive polymer layer” of the present invention. The filler material 4 serves as the “filler material having a negative linear expansion coefficient” of the present invention. The cathode layer 5 serves as the “cathode layer” of the present invention.

### [Manufacturing Process]

A process for manufacturing the solid electrolytic capacitor of the preferred embodiment shown in FIG. 1 will now be discussed.

Step 1: A green body, which is formed by performing pressurized molding on metal powder having a valve effect so as to embed part of the anode lead 1a, is sintered in a vacuum environment to form the anode body 1, which is a porous sintered body, around the anode lead 1a. In this process, the metal powder is fused to one another.

Step 2: The anode body 1 is anodized in an electrolytic solution to form the dielectric layer 2, which is an oxide of the valve metal, with a predetermined thickness so as to enclose the anode body 1.

Step 3: Chemical polymerization is performed to form the conductive polymer layer 3 on the surface of the dielectric layer 2. Specifically, the conductive polymer layer 3 is formed by performing oxidative polymerization on a monomer with an oxidant using a chemical polymerization liquid in which the monomer and the oxidant are dissolved. In the preferred embodiment, oxidative polymerization is performed by mixing the filler material 4, which has a negative linear expansion coefficient, in a chemical polymerization liquid so as to contain the filler material 4 at a predetermined content in the conductive polymer layer 3. In this process, the filler material 4 is added throughout the conductive polymer layer 3, which is formed on the surface of the dielectric layer 2.

Step 4: A conductive carbon paste, which contains carbon grains, is applied to and dried on the conductive polymer layer 3 to form the conductive carbon layer 5a. Further, silver paste is applied to and dried on the conductive carbon layer 5a to form the silver paste layer 5b. This forms the cathode layer 5, which is a laminated film of the conductive carbon layer 5a and the silver paste layer 5b, on the conductive polymer layer 3.

By performing the above-described steps 1 to 4, the capacitor element 10 is manufactured.

Step 5: After applying conductive adhesive (not shown) to the plate-shaped cathode terminal 7, the conductive adhesive (not shown) is dried between the cathode layer 5 and the cathode terminal 7 so as to bond the cathode layer 5 and the cathode terminal 7 with the conductive adhesive. The plate-shaped anode terminal 6 is spot-welded and bonded to the anode lead 1a.

Step 6: A transfer process is performed to mold the mold package 8 around the capacitor element 10. In this process, the mold package 8 is molded so as to accommodate the anode lead 1a, the anode body 1, the dielectric layer 2, the conductive polymer layer 3, and the cathode layer 5 in a state in which the end portions of the anode terminal 6 and the cathode terminal 7 extend out of the mold package 8 in opposite directions. The resin for molding the mold package 8 is preferably a resin (e.g., epoxy resin) having small water absorption so as to prevent the passage of moisture through the mold package 8 and prevent cracking and stripping during reflow soldering (heating treatment)

Step 7: The anode terminal 6 and cathode terminal 7 that are exposed from the mold package 8 are trimmed to predetermined lengths. Further, the distal portions of the anode terminal 6 and the cathode terminal 7 exposed from the mold package 8 are bent downward and arranged along the side surface and the lower surface of the mold package 8. The distal portions of the two terminals function as terminals of the solid electrolytic capacitor and are used to electrically connect the solid electrolytic capacitor to a mounting substrate with a solder member.

Step 8: Finally, an aging process is performed by applying a predetermined voltage to the two terminals of the solid electrolytic capacitor. This stabilizes the properties of the solid electrolytic capacitor.

By performing the above steps, the solid electrolytic capacitor in the preferred embodiment is manufactured.

### Example

First, as preliminary experiments 1 to 3, the content of the filler material contained in the conductive polymer layer formed through chemical polymerization was evaluated.

### Preliminary Experiment 1

First, 20 mg of grain-like powder of zirconium tungstate (ZrW₂O₈), which serves as filler material, and 2 mg of para-toluenesulfonic acid iron (III), which serves as a dopant-oxidant, were uniformly mixed in 100 g of an ethanol solution containing 1% by weight of pyrrole, which serves as polymerization monomer, to prepare a chemical polymerization liquid. Then, an anode body on which a dielectric layer was formed was impregnated in the chemical polymerization liquid and left in a room temperature environment (25° C.) for twenty-four hours to advance the polymerization reaction and form a conductive polymer film (thickness: approximately 100 μm) on the dielectric layer. The formed conductive polymer film was stripped from the dielectric layer and used as analysis sample S1.

Next, a qualitative and quantitative analysis was conducted on the analysis sample S1 to quantify the zirconium tungstate in the conductive polymer film of the analysis sample S1. More specifically, organic elemental analysis was conducted to obtain the composition of carbon (C), hydrogen (H), and nitrogen (N) in the analysis sample S1, and an electron probe micro analyzer (EPMA) was used to quantify the content of carbon (C), sulfur (S), zirconium (Zr), and tungsten (W) in the analysis sample S1. From the results of the two analyses, the content of zirconium tungstate serving as a filler material in the conductive polymer film was calculated to be 1% by weight. The zirconium tungstate used here was obtained by pulverizing zirconium tungstate sold and manufactured by Wako Pure Chemical Industries, Ltd. and sieving the pulverized zirconium tungstate with a sieve having a nominal size of 75 micrometers (converted meshing 200).

### Preliminary Experiment 2

Further, 15 mg of grain-like powder of beta-eucryptite (Li₂O.Al₂O₃.2SiO₂), which is a lithium-aluminum-silicon oxide serving as filler material, and 2 mg of para-toluenesulfonic acid iron (III), which serves as a dopant-oxidant, were uniformly mixed in 100 g of an ethanol solution containing 1% by weight of pyrrole, which serves as polymerization monomer, to prepare a chemical polymerization liquid. Then, an anode body on which a dielectric layer was formed was impregnated in the chemical polymerization liquid and left in a room temperature environment (25° C.) for twenty-four hours to advance the polymerization reaction and form a conductive polymer film (thickness: approximately 100 μm) on the dielectric layer. The formed conductive polymer film was stripped from the dielectric layer and used as analysis sample S2.

Next, a qualitative and quantitative analysis was conducted on the analysis sample S2 to quantify the beta-eucryptite in the conductive polymer film of the analysis sample S2. More specifically, the organic elemental analysis was conducted to obtain the composition of carbon (C), hydrogen (H), and nitrogen (N) in the analysis sample S2, and the EPMA was used to quantify the content of carbon (C), sulfur (S), aluminum (Al), and silicon (Si) in the analysis sample S2. From the results of the two analyses, the content of beta-eucryptite serving as a filler material in the conductive polymer film was calculated to be 1% by weight. The beta-eucryptite used here was obtained by molding commercially sold beta-eucryptite solid solution, pulverizing eucryptite pellets that were sintered under a temperature of 1000° C. for ten hours, and sieving the pulverized pellets with a sieve having a nominal size of 75 micrometers (converted meshing 200).

### Preliminary Experiment 3

Further, 25 mg of grain-like powder of copper-germanium-manganese nitride [Mn₃(Cu_{0.5}Ge_{0.5})N], which serves as filler material, and 2 mg of para-toluenesulfonic acid iron (III), which serves as a dopant-oxidant, were uniformly mixed in 100 g of an ethanol solution containing 1% by weight of pyrrole, which serves as polymerization monomer, to prepare a chemical polymerization liquid. Then, an anode body on which a dielectric layer was formed was impregnated in the chemical polymerization liquid and left in a room temperature environment (25° C.) for twenty-four hours to advance the polymerization reaction and form a conductive polymer film (thickness: approximately 100 μm) on the dielectric layer. The formed conductive polymer film was stripped from the dielectric layer and used as analysis sample S3.

Next, a qualitative and quantitative analysis was conducted on the analysis sample S3 to quantify the copper-germanium-manganese nitride in the conductive polymer film of the analysis sample S2. More specifically, the organic elemental analysis was conducted to obtain the composition of carbon (C), hydrogen (H), and nitrogen (N) in the analysis sample S3, and the EPMR was used to quantify the content of carbon (C), sulfur (S), manganese (Mn), copper (Cu), germanium (Ge), and nitrogen (N) in the analysis sample S3. From the results of the two analyses, the content of copper-germanium-manganese nitride serving as a filler material in the conductive polymer film was calculated to be 1% by weight. The copper-germanium-manganese nitride used here was obtained by pulverizing copper-germanium-manganese nitride in accordance with the procedures described below and sieving the pulverized copper-germanium-manganese nitride with a sieve having a nominal size of 75 micrometers (converted meshing 200).

First, manganese nitride (Mn₂N) and copper (Cu) were mixed in a nitrogen atmosphere and then thermally processed in a hermetic state at a temperature of 750° C. for fifty hours to produce copper-manganese nitride (Mn₃CuN). In the same manner, manganese nitride (Mn₂N) and germanium (Ge) were mixed in a nitrogen atmosphere and then thermally processed in a hermetic state at a temperature of 750° C. for fifty hours to produce germanium-manganese nitride (Mn₃CuN). The copper-manganese nitride and the germanium-manganese nitride were pulverized and the same amount were mixed and molded to form pellets, which were thermally processed in a nitrogen atmosphere at a temperature of 800° C. for sixty hours. This formed the copper-germanium-manganese nitride [Mn₃(Cu_{0.5}Ge_{0.5})N], which was molded into pallets.

Next, as preliminary experiments 4 to 6, the linear expansion coefficient of the filler material contained in the conductive polymer layer was evaluated.

In the linear expansion coefficient evaluation, thermo-mechanical analysis was conducted on the molded sample of each filler material in a state in which a measurement load of two grams was applied to the molding example by raising the temperature in air from 50° C. to 100° C. at a rate of 5°/min and measuring the change in the length of the molded example. Then, the linear expansion coefficient was calculated using each measurement value from equation (1), which is shown below. The average value of the linear expansion coefficient for three molded samples was taken as the linear expansion coefficient of the filler material.

Linear Expansion Coefficient=ΔL/(L×ΔT) (1)

Here, L represents the length of the molded sample under a temperature of 50° C., ΔL represents the difference between the lengths of the molded sample at 50° C. and 100° C., and ΔT represents the temperature difference between 50° C. and 100° C. (50° C.).

### Preliminary Example 4

Zirconium tungstate powder was pressed and molded into pellets and sintered in an electric furnace at a temperature of 1200° C. for five hours to produce molded sample S4 for zirconium tungstate. The linear expansion coefficient of molded sample S4 was evaluated as being −8.0×10⁻⁶/° C., which is a negative linear expansion coefficient.

### Preliminary Example 5

The eucryptite pellets molded in preliminary example 2 were used as molded sample S5 for beta-eucryptite. The linear expansion coefficient of molded sample S4 was evaluated as being −6.5×10⁻⁶/° C., which is a negative linear expansion coefficient.

### Preliminary Example 6

The pellets of copper-germanium-manganese nitride molded in preliminary example 3 were used as molded sample S6. The linear expansion coefficient of molded sample S6 was evaluated as being −11.5×10⁻⁶/° C., which is a negative linear expansion coefficient.

Next, examples 1 to 24 (solid electrolytic capacitors A1 to A18 and B1 to B6) and comparative examples 1 and 2 (solid electrolytic capacitors X and Y), which were produced to evaluate the characteristics of the solid electrolytic capacitor of the preferred embodiment, will be described. In each of the examples, the content of the filler material in the conductive polymer layer is adjusted based on the results of preliminary experiments 1 to 6.

### Example 1

In example 1, a solid electrolytic capacitor A1 was produced by carrying out steps 1A to 8A, which correspond to steps 1 to 8 in the manufacturing process of the preferred embodiment.

Step 1A: Niobium metal powder of which CV value is 100,000 μF·V/g was prepared. The CV value is the product for the volume and voltage of a niobium porous sintered body after the formation of a dielectric layer. The niobium metal powder was used to mold a green body (size: 4.5 mm×3.3 mm×1.0 mm) so as to embed part of the anode lead 1a (diameter 0.5 mm), which is formed from tantalum. The green body was sintered in a vacuum environment under a temperature of 1100° C. to form the anode body 1, which is a niobium porous sintered body. In this process, the niobium metal powder is fused to one another. Hereinafter, unless otherwise specified, the CV in each of the examples and comparative examples is 100,000 μF·V/g.

Step 2A: The sintered anode body 1 is anodized in a phosphoric acid aqueous solution of approximately 0.1% by weight and held at a temperature of approximately 60° C. for approximately ten hours under a constant voltage of approximately 10 V. This forms the dielectric layer 2 from niobium oxide (tantalum oxide on the surface of the anode lead 1a) so as to enclose the anode body 1.

Step 3A: Further, 20 mg of granular zirconium tungstate (ZrW₂O₈) powder, which serves as filler material, and 2 g of para-toluenesulfonic acid iron (III), which serves as a dopant-oxidant, were uniformly mixed in 100 g of an ethanol solution containing 1% by weight of pyrrole, which serves as polymerization monomer, to prepare a chemical polymerization liquid. Then, an anode body on which a dielectric layer was formed was impregnated in the chemical polymerization liquid and left in a room temperature environment (25° C.) for twenty-four hours to advance the polymerization reaction and form a conductive polymer film (thickness: approximately 100 μm) on the dielectric layer. In this process, zirconium tungstate serving as the filler material 4 was added in the conductive polymer layer 3 at a content of 1% by weight. The zirconium tungstate was uniformly added throughout the conductive polymer layer 3, which was formed on the surface of the dielectric layer 2.

Step 4A: A conductive carbon paste was applied to and dried on the conductive polymer layer 3 to form the conductive carbon layer 5a, which contains carbon grains. Further, silver paste was applied to and dried on the conductive carbon layer 5a to form the silver paste layer 5b, which contains silver grains. This forms the cathode layer 5, which is a laminated film of the conductive carbon layer 5a and the silver paste layer 5b, on the conductive polymer layer 3.

Step 5A: After applying a conductive adhesive (not shown) to the plate-shaped cathode terminal 7, the conductive adhesive (not shown) was dried between the cathode layer 5 and the cathode terminal 7 so as to bond the cathode layer 5 and the cathode terminal 7 with the conductive adhesive. The plate-shaped anode terminal 6 was spot-welded and bonded to the anode lead 1a.

Step 6A: A transfer process was performed to mold a mold package from epoxy resin. More specifically, the capacitor element 10 was arranged in a mold (between upper and lower molds). An epoxy resin was charged into the mold in a heated, softened, and pressurized state so as to fill the gaps between the capacitor element 10 and the walls of the mold. Subsequently, the high temperature was held over a constant time to harden the epoxy resin. This formed the generally box-shaped mold package 8 of epoxy resin around the capacitor element 10. In this process, the mold package 8 was molded so as to accommodate the capacitor element 10 (the anode lead 1a, the anode body 1, the dielectric layer 2, the conductive polymer layer 3, and the cathode layer 5) in a state in which the end portions of the anode terminal 6 and the cathode terminal 7 extend out of the mold package 8 in opposite directions.

Step 7A: The anode terminal 6 and cathode terminal 7 that are exposed from the mold package 8 were trimmed to predetermined lengths. Further, the distal portions of the anode terminal 6 and the cathode terminal 7 exposed from the mold package 8 were bent downward and arranged along the side surface and the lower surface of the mold package 8.

Step 8A: Finally, an aging process was performed by applying a rated voltage of 2.5 V to the two terminals of the solid electrolytic capacitor at a temperature of 130° C. for two hours.

By performing the above steps, the solid electrolytic capacitor A1 of example 1 was produced.

### Examples 2 to 6

In examples 2 to 6, solid electrolytic capacitors A2 to A6 were produced in a manner similar to example 1. The only difference from example 1 was step 3A. In examples 2 to 6, the content of zirconium tungstate serving as the filler material 4 in the conductive polymer layer 3 was 5% by weight, 10% by weight, 20% by weight, 30% by weight, and 40% by weight, respectively.

### Example 7

In example 7, solid electrolytic capacitor A7 was produced in a manner similar to example 1. The only difference was in that step 3A of example 1 was changed to step 3B as described below to add beta-eucryptite (Li₂O.Al₂O₃.2SiO₂), which is a lithium-aluminum-silicon oxide, to the conductive polymer layer 3.

Step 3B: Here, 15 mg of granular beta-eucryptite powder, which serves as filler material, and 2 g of para-toluenesulfonic acid iron (III), which serves as a dopant-oxidant, were uniformly mixed in 100 g of an ethanol solution containing 1% by weight of pyrrole, which serves as polymerization monomer, to prepare a chemical polymerization liquid. Then, the anode body 1, on which the dielectric layer 2 was formed, was impregnated in the chemical polymerization liquid and left in a room temperature environment (25° C.) for twenty-four hours to advance the polymerization reaction and form the conductive polymer layer 3 (thickness: approximately 100 μm) on the dielectric layer. In this process, beta-eucryptite serving as the filler material 4 was added in the conductive polymer layer 3 at a content of 1% by weight. The beta-eucryptite was uniformly added throughout the conductive polymer layer 3, which was formed on the surface of the dielectric layer 2.

### Examples 8 to 12

In examples 8 to 12, solid electrolytic capacitors AS to A12 were produced in a manner similar to example 7. The only difference from example 7 was step 3B. In examples 8 to 12, the content of beta-eucryptite serving as the filler material 4 in the conductive polymer layer 3 was 5% by weight, 10% by weight, 20% by weight, 30% by weight, and 40% by weight, respectively.

### Example 13

In example 13, solid electrolytic capacitor A13 was produced in a manner similar to example 1. The only difference was in that step 3A of example 1 was changed to step 3C as described below to add copper-germanium-manganese nitride [Mn₃(Cu_{0.5}Ge_{0.5})N] to the conductive polymer layer 3.

Step 3C: Here, 15 mg of granular copper-germanium-manganese nitride powder, which serves as filler material, and 2 g of para-toluenesulfonic acid iron (III), which serves as a dopant-oxidant, were uniformly mixed in 100 g of an ethanol solution containing 1% by weight of pyrrole, which serves as polymerization monomer, to prepare a chemical polymerization liquid. Then, the anode body 1, on which the dielectric layer 2 was formed, was impregnated in the chemical polymerization liquid and left in a room temperature environment (25° C.) for twenty-four hours to advance the polymerization reaction and form the conductive polymer layer 3 (thickness: approximately 100 μm) on the dielectric layer. In this process, copper-germanium-manganese nitride serving as the filler material 4 was added in the conductive polymer layer 3 at a content of 1% by weight. The copper-germanium-manganese nitride was uniformly added throughout the conductive polymer layer 3, which was formed on the surface of the dielectric layer 2.

### Examples 14 to 18

In examples 14 to 18, solid electrolytic capacitors A14 to A18 were produced in a manner similar to example 13. The only difference from example 7 was step 3C. In examples 14 to 18, the content of copper-germanium-manganese nitride serving as the filler material 4 in the conductive polymer layer 3 was 5% by weight, 10% by weight, 20% by weight, 30% by weight, and 40% by weight, respectively.

### Comparative Example 1

In comparative example 1, a solid electrolytic capacitor X was produced in a manner similar to example 1. The only difference from example 1 was step 3A. Here, a chemical polymerization liquid that does not contain the filler material 4 was used to form the conductive polymer layer 3.

### Example 19

In comparative example 19, a solid electrolytic capacitor B1 was produced in a manner similar to example 1. The only difference from example 1 was step 1A. Here, tantalum metal powder was used in lieu of niobium metal powder to form the anode body 1, which is a porous sintered body. For tantalum metal powder, sintering was performed in vacuum environment under a temperature of 1050° C.

### Example 20 to 24

In Examples 20 to 24, solid electrolytic capacitors B2 to B6 were produced in a manner similar to example 19. The only difference from example 19 was step 3A, which was described in example 1. In examples 20 to 24, the amount of zirconium tungstate added to the chemical polymerization liquid was adjusted so that the content of zirconium tungstate serving as the filler material 4 in the conductive polymer layer 3 becomes 5% by weight, 10% by weight, 20% by weight, 30% by weight, and 40% by weight, respectively.

### Comparative Example 2

In comparative example 2, a solid electrolytic capacitor Y was produced in a manner similar to example 19. The only difference from example 19 was step 3A, which was described in example 1. Here, a chemical polymerization liquid that does not contain zirconium tungstate as the filler material 4 was used to form the conductive polymer layer 3.

### [Evaluation]

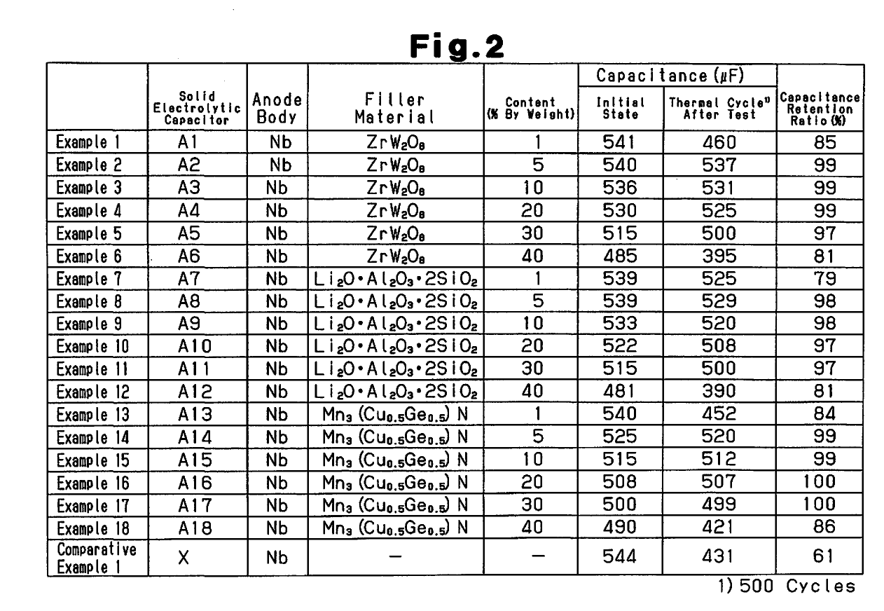

The capacitance retention ratio was evaluated for solid electrolytic capacitors using niobium metal for the anode body. FIG. 2 illustrates capacitance retention ratio evaluation results for solid electrolytic capacitors using niobium metal. The value of each capacitance retention ratio in FIG. 2 is the average for 100 evaluation samples.

The capacitance retention ratio is calculated from equation (2), which is shown below, using capacitances taken before and after a thermal cycle. A value that is closer to 100 indicates that the capacitance has been lowered (deteriorated) less by a thermal load.

Capacitance Retention Ratio (%)=(Capacitance After Thermal Cycle Test/Capacitance Before Thermal Cycle Test)×100 (2)

A thermal cycle test repeats a cycle of −30° C. (30 min.) and +85° C. (30 min.) for 500 times.

The capacitance (capacitance of the solid electrolytic capacitor when the frequency is 120 Hz) was measured for each evaluation sample of the solid electrolytic capacitor with an LCR meter after performing heat treatment for one minute under a maximum temperature of 260° C. (initial state: before thermal cycle test) and after the thermal cycle test. The capacitor of the thermal cycle test was measured subsequent to the thermal cycle test one hour after returning the evaluation sample to room temperature.

As shown in FIG. 2, it is apparent in comparative example 1 of the prior art (solid electrolytic capacitor X) that the thermal cycle test lowered the capacitance such that the capacitance retention ratio became 61%. Generally, polymer material such as polypyrrole has a tendency to expand or contract as the ambient temperature increases or decreases. Accordingly, in a test such as a thermal cycle test in which high temperature and low temperature loads are repeated, a conductive polymer layer formed from a conductive polymer would repeatedly expand and contract such that the conductive polymer layer would ultimately be stripped from the dielectric layer. For this reason, it is assumed that stripping of the conductive polymer layer caused by the thermal cycle test resulted in the low capacitance retention ratio (lowered capacitance).

As for examples 1 to 18 (solid electrolytic capacitors A1 to A18) in which the conductive polymer layer contains filler material having a negative linear expansion coefficient (i.e., zirconium tungstate, lithium-aluminum-silicon oxide, and copper-germanium-manganese nitride), the capacitance retention ratio was in the range of 79% to 100%. Thus, it is apparent that capacitance decrease resulting from the thermal cycle test was suppressed as compared to comparative example 1 of the prior art. It is assumed that expansion or contraction of the conductive polymer layer was suppressed when the ambient temperature increased or decreased thereby suppressing capacitance decrease resulting from the thermal cycle test.

Further, in examples 1 to 18, it is apparent that the capacitance in the initial state is decreased in comparison with comparative example 1 of the prior art. It is assumed that this is because the portions of each filler material in contact with the dielectric layer that do not contribute to formation of a capacitor reduces the contact area between the conductive polymer layer and the dielectric layer that affects the increase or decrease in capacitance.

Further, in examples 1 to 18, when the content of each filler material is in the range of 5% by weight to 30% by weight, the capacitance retention ratio is 95% or greater (actually, 97% to 100%). It is thus apparent that decrease in capacitance is further suppressed. The effect for suppressing a capacitance decrease is relatively low when the content of each filler material is 1% by weight (examples 1, 7, and 13). It is assumed that this is because the content of the filler material in the conductive polymer layer was small, and expansion or contraction of the conductive polymer layer was sufficiently suppressed when the ambient temperature increased or decreased. Further, the effect for suppressing a capacitance decrease is relatively low when the content of each filler material is 40% by weight (examples 6, 12, and 18). It is assumed that this is because the portions of the filler material in contact with the dielectric layer is increased in comparison with the other examples and thereby reduces the contact area between the dielectric layer and the conductive polymer layer that affects the increase or decrease in capacitance.

As described above, it is apparent that a filler material having a negative linear expansion coefficient (i.e., zirconium tungstate, lithium-aluminum-silicon oxide, and copper-germanium-manganese nitride) in the conductive polymer layer is effective for providing a solid electrolytic capacitor that suppresses capacitance decrease caused by thermal loads. Further, it is preferable that the content of such a filler material be in the range of 5% by weight to 30% by weight.

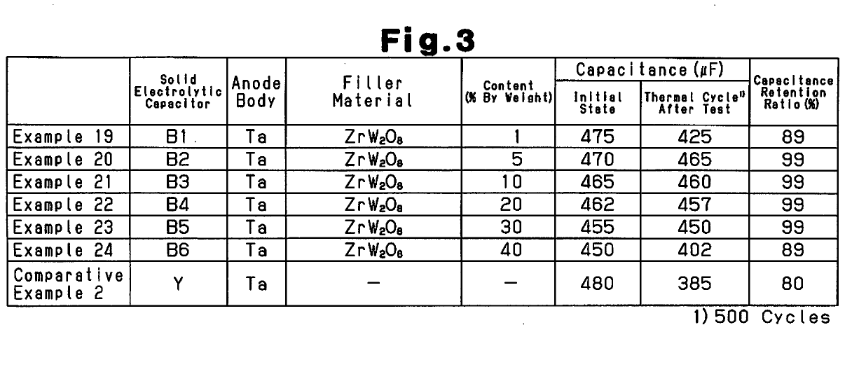

Next, the capacitance retention ratio was evaluated for solid electrolytic capacitors using tantalum metal for the anode body. FIG. 3 illustrates capacitance retention ratio evaluation results for tantalum solid electrolytic capacitors. The value of each capacitance retention ratio in FIG. 3 is the average for 100 evaluation samples.

As shown in FIG. 3, it is apparent in comparative example 2 of the prior art (solid electrolytic capacitor Y) that the thermal cycle test lowered the capacitance such that the capacitance retention ratio became 80%. This capacitance retention ratio is improved compared to comparison example 1 (solid electrolytic capacitor X), which uses niobium metal. However, in examples 19 to 24 (solid electrolytic capacitors B1 to B6) containing filler material (zirconium tungstate) having a negative linear expansion coefficient in the conductive polymer layer, the capacitance retention ratio is in the range of 89% to 99%. Thus, in comparison with comparative example 2 of the prior art, capacitance decrease caused by the thermal cycle test is further suppressed. Particularly, in examples 19 to 24 in which the content of the filler material is in the range of 5% by weight to 30% by weight, the capacitance retention ratio is 95% or greater (actually 99%), and capacitance decrease is further suppressed. It is assumed that this is for the same reasons as described above for the niobium solid electrolyte capacitors.

As described above, in the same manner as when using niobium metal for the anode body, it is apparent that a filler material having a negative linear expansion coefficient (i.e., zirconium tungstate) in the conductive polymer layer is also effective when using tantalum metal for providing a solid electrolytic capacitor that suppresses capacitance decrease caused by thermal loads. Further, it is preferable that the content of such a filler material be in the range of 5% by weight to 30% by weight.

The solid electrolytic capacitor of the preferred embodiment and the method for manufacturing such a solid electrolytic capacitor has the advantages described below.

(1) Expansion or contraction of the conductive polymer layer 3 caused by thermal loads (thermal cycle test) is suppressed by containing the filler material 4, which has a negative linear expansion coefficient, in the conductive polymer layer 3. This prevents stripping of the conductive polymer layer 3 and suppresses capacitance decrease of the solid electrolytic capacitor.

(2) The filler material 4 is distributed throughout the conductive polymer layer 3, which is formed on the dielectric layer 2. This prevents stripping of the conductive polymer layer 3 at the entire interface between the dielectric layer 2 and the conductive polymer layer 3 and further ensures that decrease in capacitance is suppressed.

(3) It is preferred that the content of the filler material 4 in conductive polymer layer 3 be in the range of 5% by weight to 30% by weight since this would further ensure that the capacitance is decreased.

(4) The filler material 4 having a negative linear expansion coefficient may be at least one selected from zirconium tungstate, lithium-aluminum-silicon oxide, and copper-germanium-manganese nitride. By adding such a filler material, expansion or contraction of the conductive polymer layer 3 caused by thermal loads (thermal cycle test) is suppressed, and the above-described advantages (1) to (3) may be obtained.

(5) In the manufacturing method of the preferred embodiment, an optimal solid electrolytic capacitor having the above-described advantages (1) to (4) may be manufactured just by adding the filler material 4, which has a negative linear expansion coefficient, to the conductive polymer layer 3.

It should be apparent to those skilled in the art that the present invention may be embodied in many other specific forms without departing from the spirit or scope of the invention. Particularly, it should be understood that the present invention may be embodied in the following forms.

In the preferred embodiment, the solid electrolytic capacitor uses an anode body, which is a porous sintered body formed from metal powder of a valve metal. However, the present invention is not limited in such a manner. For example, the solid electrolytic capacitor may use an anode body formed from a metal plate (or metal foil) having a valve effect. In such a case, the same advantages as in the preferred embodiment are obtained.

In the preferred embodiment, the conductive polymer layer (conductive polymer layer containing an additive having a negative linear expansion coefficient) is formed by performing chemical polymerization. However, the present invention is not limited in such a manner. For example, electropolymerization may be performed to form the conductive polymer layer. Alternatively, chemical polymerization and electropolymerization may be combined to form the conductive polymer layer. In such cases, the same advantages as in the preferred embodiment are obtained.

In the preferred embodiment, granular filler material is added to the conductive polymer layer. However, the present invention is not limited in such a manner. For example, flakes or fibers of a filler material may be added to the conductive polymer layer. Alternatively, a mixture of powder, flakes, and fibers of a filler material may be added to the conductive polymer layer. In such cases, the same advantages as the preferred embodiment are obtained.

In one example of the preferred embodiment, lithium-aluminum-silicon oxide (beta-eucryptite), which is expressed as Li₂O.Al₂O₃.2SiO₂, is used as a filler material. However, the present invention is not limited in such a manner. For example, lithium-aluminum-silicon oxide expressed as (Li₂O.Al₂O₃)ₓ.(SiO₂)_{y}, in which 0≦x≦⅓, ⅔≦y≦1, and x+y=1 are satisfied, may be used as the filler material.

In one example of the preferred embodiment, copper-germanium-manganese nitride, which is expressed as Mn₃(Cu_{0.5}Ge_{0.5})N, is used as a filler material. However, the present invention is not limited in such a manner. For example, copper-germanium-manganese nitride, which is expressed as Mn₃(Cu₁₋ₓGeₓ)N, in which 0≦x≦1 is satisfied, may be used as the filler material.

In one example of the preferred embodiment, a filler material may be one selected from zirconium tungstate, lithium-aluminum-silicon oxide, and copper-germanium-manganese nitride. However, the present invention is not limited in such a manner. For example, a plurality (two or more types) of filler materials may be used. This obtains the same advantages as the preferred embodiment.

The present examples and embodiments are to be considered as illustrative and not restrictive, and the invention is not to be limited to the details given herein, but may be modified within the scope and equivalence of the appended claims.

What is claimed is:

1. A solid electrolytic capacitor comprising:
an anode body;
a dielectric layer formed on a surface of the anode body;
a conductive polymer layer formed on the dielectric layer; and
a cathode layer formed on the conductive polymer layer;
wherein the conductive polymer layer contains a filler material having a negative linear expansion coefficient.

2. The solid electrolytic capacitor according to claim 1, wherein the filler material is substantially distributed throughout the conductive polymer layer formed on the dielectric layer.

3. The solid electrolytic capacitor according to claim 1, wherein the filler material is contained in the range of 5% by weight to 30% by weight with respect to the total weight of the conductive polymer layer and the filler material.

4. The solid electrolytic capacitor according to claim 1, wherein the filler material is at least one selected from the group consisting of zirconium tungstate, lithium-aluminum-silicon oxide, and copper-germanium-manganese nitride.

5. A method for manufacturing a solid electrolytic capacitor comprising:
forming an anode body from a valve metal;
forming a dielectric layer on a surface of the anode body by anodizing the anode body;
forming a conductive polymer layer on the dielectric layer by using a polymerization liquid containing a filler material that has a negative linear expansion coefficient so that the conductive polymer layer contains the filler material; and
forming a cathode layer on the conductive polymer layer.
